(19) United States
(12) Patent Application Publication
(10) Pub. No.: US 2025/0304835 A1
(43) Pub. Date: Oct. 2, 2025

(54) Aqueous Pressure-Sensitive Adhesive Composition

(71) Applicant: SEIKO EPSON CORPORATION, Tokyo (JP)

(72) Inventors: Nikako TSUKIJI, Matsumoto (JP); Soichi YAMAZAKI, Shiojiri (JP); Harunobu KOMATSU, Matsumoto (JP)

(21) Appl. No.: 19/092,103

(22) Filed: Mar. 27, 2025

(30) Foreign Application Priority Data
Mar. 28, 2024 (JP) 2024-053106

(51) Int. Cl. C09J 7/38; B41J 3/407; B41J 15/04; B41J 29/17; B65G 45/12; B65G 45/22; C09J 5/00; D06P 5/30

(52) U.S. Cl. CPC C09J 7/385; B41J 3/4078; B41J 15/048; B41J 29/17; B65G 45/12; B65G 45/22; C09J 5/00; D06P 5/30; C09J 2203/358; C09J 2301/302; C09J 2301/502

(57) ABSTRACT

Provided is an aqueous pressure-sensitive adhesive composition for forming a pressure-sensitive adhesive layer at a surface of a fabric transport member of an ink jet textile printing apparatus, the aqueous pressure-sensitive adhesive composition including: a (meth)acrylic resin; and water, in which the (meth)acrylic resin includes a constituent unit having an alkylene oxide chain of which the number of repetitions is 10 or more at a side chain, and an acid value of the (meth)acrylic resin is more than 0 mgKOH/g.

The present application is based on, and claims priority from JP Application Serial Number 2024-053106, filed Mar. 28, 2024, the disclosure of which is hereby incorporated by reference herein in its entirety.

### BACKGROUND

### 1. Technical Field

The present disclosure relates to an aqueous pressure-sensitive adhesive composition.

### 2. Related Art

Ink jet recording methods enable recording of high-definition images with relatively simple apparatuses and are rapidly developed in various fields. Among the fields, various studies have been conducted on discharge stability and the like. For example, JP-A-2020-109036 discloses a transport device including: a transport member that rotates in a predetermined direction and supports a recording medium; a cleaning device that cleans a surface of the transport member where the recording medium is supported using a cleaning solution; a removal member that abuts against the transport member and removes the cleaning solution on the transport member; and a displacement suppressing member that suppresses displacement of the transport member in a direction intersecting a movement direction of the transport member during the rotation of the transport member.

As described in JP-A-2020-109036, an ink jet textile printing apparatus in the related art performs printing such that a pressure-sensitive adhesive layer is formed at a transport member such as an endless belt, fabric that is a recording medium is bonded to the pressure-sensitive adhesive layer, the fabric is transported to a printing portion, recording is performed on the fabric, and the fabric is peeled off from the transport member. The pressure-sensitive adhesive layer for the fabric transport member is formed at the surface of the transport member, and the surface of the transport member has adhesion.

On the transport member from which the fabric is peeled off, ink attached to the transport member in a printing step, waste thread, and other residual members remain. Therefore, these residual members need to be removed before the fabric is bonded to the transport member again. Typically, the residual members such as ink attached to the transport member and waste thread are cleaned by water. At this time, a brush, a sponge, or the like that cleans the transport member may also be used.

For the pressure-sensitive adhesive layer used for the ink jet textile printing, a composition obtained by dissolving a hydrophobic resin in an organic solvent is generally used to endure water cleaning. However, in order to reduce the environmental burden or to improve a work environment, an aqueous pressure-sensitive adhesive composition where the amount of the organic solvent used is reduced is required as a pressure-sensitive adhesive composition for forming the pressure-sensitive adhesive layer.

### SUMMARY

According to an aspect of the present disclosure, there is provided an aqueous pressure-sensitive adhesive composition for forming a pressure-sensitive adhesive layer at a surface of a fabric transport member of an ink jet textile printing apparatus, the aqueous pressure-sensitive adhesive composition including: a (meth)acrylic resin; and water, in which the (meth)acrylic resin includes a constituent unit having an alkylene oxide chain of which the number of repetitions is 10 or more at a side chain, and an acid value of the (meth)acrylic resin is more than 0 mgKOH/g.

According to an aspect of the present disclosure, there is provided an adhesion imparting method including: attaching the above-described aqueous pressure-sensitive adhesive composition to a surface of a fabric transport member of an ink jet textile printing apparatus to form a pressure-sensitive adhesive layer.

According to an aspect of the present disclosure, there is provided an ink jet textile printing apparatus including: a transport mechanism that transports a fabric, the fabric being bonded to a pressure-sensitive adhesive layer of the above-described aqueous pressure-sensitive adhesive composition formed at a surface of a fabric transport member; a recording portion that performs textile printing recording on the fabric bonded to the pressure-sensitive adhesive layer using an ink jet head; and a cleaning portion that cleans the pressure-sensitive adhesive layer from which the fabric is peeled off after the textile printing recording.

According to an aspect of the present disclosure, there is provided a fabric transport member of an ink jet textile printing apparatus, the fabric transport member including: a pressure-sensitive adhesive layer derived from the above-described aqueous pressure-sensitive adhesive composition on a surface.

According to an aspect of the present disclosure, there is provided an ink jet textile printing method including: transporting a fabric, the fabric being bonded to a pressure-sensitive adhesive layer of the above-described aqueous pressure-sensitive adhesive composition formed at a surface of a fabric transport member of an ink jet textile printing apparatus; performing textile printing recording on the fabric bonded to the pressure-sensitive adhesive layer using an ink jet head; and cleaning the pressure-sensitive adhesive layer from which the fabric is peeled off after the textile printing recording.

### BRIEF DESCRIPTION OF THE DRAWINGS

FIG. 1 is a schematic sectional view illustrating an ink jet textile printing apparatus.

FIG. 2 is a table illustrating Examples and Comparative Examples.

### DESCRIPTION OF EMBODIMENTS

Hereinafter, an embodiment of the present disclosure (hereinafter referred to as “the present embodiment”) is described in detail with reference to the drawings as necessary. However, the present disclosure is not limited to the embodiment and can be variously modified without deviating from the gist of the present disclosure. In the drawings, the same components are designated by the same reference numerals and the same description will be omitted. The positional relationship, such as left, right, top, and bottom, should be based on the positional relationship illustrated in the drawings unless otherwise particularly specified. Furthermore, the dimensional ratios in the drawings are not limited to the ratios illustrated in the drawings.

“(Meth)acrylate” refers to a generic expression including an acrylate and a methacrylate. In addition, “unit” such as “constituent unit” or “(meth)acrylate unit” refers to a repeating unit derived from a monomer when the monomer is polymerized into a polymer.

### 1. Aqueous Pressure-Sensitive Adhesive Composition

An aqueous pressure-sensitive adhesive composition according to the present embodiment is an aqueous pressure-sensitive adhesive composition for forming a pressure-sensitive adhesive layer at a surface of a fabric transport member of an ink jet textile printing apparatus, the aqueous pressure-sensitive adhesive composition including: a (meth)acrylic resin; and water, in which the (meth)acrylic resin includes a constituent unit having an alkylene oxide chain of which the number of repetitions is 10 or more at a side chain, and an acid value of the (meth)acrylic resin is more than 0 mgKOH/g.

With the above-described configuration, the aqueous pressure-sensitive adhesive composition according to the present embodiment can form a pressure-sensitive adhesive layer that can be peeled off with an aqueous solvent. Hereinafter, each of the components in the aqueous pressure-sensitive adhesive composition will be described in detail.

### 1.1. (Meth)Acrylic Resin

The (meth)acrylic resin includes a constituent unit having an alkylene oxide chain of which the number of repetitions is 10 or more at a side chain, and an acid value of the (meth)acrylic resin is more than 0 mgKOH/g. By including the (meth)acrylic resin, the peelability of the formed pressure-sensitive adhesive layer tends to be further improved.

The (meth)acrylic resin may be a water-soluble resin or may be a resin emulsion dispersed in an aqueous solvent. The water-soluble resin and the resin emulsion will also be generically referred to the (meth)acrylic resin in the present embodiment. In addition, the (meth)acrylic resin may be obtained by copolymerization of an allyl monomer in addition to a (meth)acrylate. By using the (meth)acrylic resin, the environmental burden by an organic solvent can be reduced, and the exfoliating property of the fabric in the pressure-sensitive adhesive layer also tends to be further improved.

The glass transition temperature of the (meth)acrylic resin is preferably −35° C. to 5° C., −30° C. to 0° C., −25° C. to −5° C., −20° C. to −5° C., or −15° C. to −7.5° C. By adjusting the glass transition temperature of the (meth)acrylic resin to be in the above-described range, the adhesive force of the obtained pressure-sensitive adhesive layer tends to be further improved.

In the present embodiment, the glass transition temperature can be measured by differential scanning calorimetry (DSC) using a well-known method of the related art. In addition, the glass transition temperature of the (meth)acrylic resin can be adjusted based on a glass transition temperature of a homopolymer of a polymerizable compound to be used and a content mass ratio of the polymerizable compound to be used.

The acid value of the (meth)acrylic resin is more than 0 mgKOH/g and is preferably 1.0 mgKOH/g to 30 mgKOH/g, 2.0 mgKOH/g to 25 mgKOH/g, 2.0 mgKOH/g to 20 mgKOH/g, 2.0 mgKOH/g to 10 mgKOH/g, or 5.0 mgKOH/g to 10 mgKOH/g. By adjusting the acid value of the (meth)acrylic resin to be more than 0 mgKOH/g, the peelability of the obtained pressure-sensitive adhesive layer tends to be further improved.

The acid value of the (meth)acrylic resin can be adjusted by adjusting the content of a monomer having an acidic group such as a carboxyl group.

The (meth)acrylic resin is preferably a resin emulsion, and an average particle size thereof is preferably 25 nm to 500 nm, 50 nm to 400 nm, 75 nm to 300 nm, 100 nm to 250 nm, or 125 nm to 200 nm. By adjusting the average particle size of the (meth)acrylic resin to be in the above-described range, the dispersion stability is further improved, and the peelability of the obtained pressure-sensitive adhesive layer tends to be further improved.

As a constituent unit, the (meth)acrylic resin includes a constituent unit having an alkylene oxide chain of which the number of repetitions is 10 or more at a side chain, and may include a constituent unit derived from an alkyl acrylate having an alkyl group, a constituent unit derived from an aromatic acrylate having an aromatic group, or a constituent unit derived from (meth)acrylic acid having a carboxyl group.

A monomer for forming the constituent unit having the alkylene oxide chain of which the number of repetitions is 10 or more at a side chain is not particularly limited, and examples thereof include a (meth)acrylate having an alkylene oxide chain of which the number of repetitions is 10 or more at a side chain, and an allyl monomer having an alkylene oxide chain of which the number of repetitions is 10 or more at a side chain.

The alkylene oxide chain is not particularly limited and may include, for example, ethylene oxide, propylene oxide, or a repeating unit including ethylene oxide and propylene oxide. Further, the number n of repetitions of the alkylene oxide chain is 10 or more and is preferably 10 to 40, 10 to 30, or 20 to 30. By adjusting the number n of repetitions to be in the above-described range, the peelability of the obtained pressure-sensitive adhesive layer tends to be further improved.

The content of the constituent unit having the alkylene oxide chain is preferably 0.1% by mass to 10% by mass, 0.3% by mass to 7.5% by mass, or 0.5% by mass to 5.0% by mass with respect to all of constituent units of the (meth)acrylic resin. By adjusting the content of the constituent unit having the alkylene oxide chain to be in the above-described range, the peelability of the obtained pressure-sensitive adhesive layer tends to be further improved.

A monomer for forming the constituent unit derived from an alkyl acrylate having an alkyl group is not particularly limited, and examples thereof include methyl methacrylate (MMA), ethyl methacrylate (EMA), butyl methacrylate (BMA), butyl acrylate (BA), and 2-ethylhexyl acrylate (2EHA).

The content of the constituent unit derived from an alkyl acrylate having an alkyl group is preferably 65% by mass to 99.9% by mass, 70% by mass to 99.8% by mass, 75% by mass to 99.7% by mass, 80% by mass to 99.6% by mass, 90% by mass to 99.5% by mass, or 90% by mass to 97% by mass with respect to all of the constituent units of the (meth)acrylic resin. By adjusting the content of the constituent unit derived from an alkyl acrylate having an alkyl group to be in the above-described range, the cleaning resistance or easy peelability of the obtained pressure-sensitive adhesive layer tends to be further improved.

The constituent unit derived from an aromatic acrylate having an aromatic group is not particularly limited, and examples thereof include styrene (St).

The content of the constituent unit derived from an aromatic acrylate is preferably 0% by mass to 30% by mass, 0% by mass to 25% by mass, or 5% by mass to 20% by mass with respect to all of the constituent units of the (meth)acrylic resin. The cleaning resistance of the obtained pressure-sensitive adhesive layer tends to be further improved.

Examples of the constituent unit derived from (meth)acrylic acid having a carboxyl group are not particularly limited, and examples thereof include acrylic acid (AA) and methacrylic acid (MA).

The content of the constituent unit derived from (meth)acrylic acid is preferably 0.1% by mass to 3.0% by mass, 0.3% by mass to 2.5% by mass, or 0.5% by mass to 2.0% by mass with respect to the total amount of the (meth)acrylic resin. By adjusting the content of the constituent unit derived from (meth)acrylic acid to be in the above-described range, the peelability, adhesion, and cleaning resistance of the obtained pressure-sensitive adhesive layer tend to be further improved.

The content of the (meth)acrylic resin is preferably 30% by mass to 70% by mass, 35% by mass to 65% by mass, 40% by mass to 60% by mass, or 45% by mass to 55% by mass with respect to the total amount of the aqueous pressure-sensitive adhesive composition. By adjusting the content of the (meth)acrylic resin to be in the above-described range, the peelability, adhesion, and cleaning resistance of the obtained pressure-sensitive adhesive layer are further improved, and the dispersion stability tends to be further improved. The content with respect to the total amount of the aqueous pressure-sensitive adhesive composition refers to the amount of solid content.

### 1.2. pH Adjuster

The pH adjuster is not particularly limited, but examples thereof include an inorganic acid (for example, sulfuric acid, hydrochloric acid, or nitric acid), an inorganic base (for example, lithium hydroxide, sodium hydroxide, potassium hydroxide, ammonia, or an ammonium salt), an organic base (triethanolamine, diethanolamine, monoethanolamine, or tripropanolamine), and an organic acid (for example, adipic acid, citric acid, or succinic acid).

In particular, ammonia or an ammonium salt is preferable. By using the above-described pH adjuster, when the pressure-sensitive adhesive layer is formed, ammonia is volatilized and the (meth)acrylic resins are likely to be attached to each other to form a coating film into which water is less likely to penetrate. Therefore, the durability of the adhesive force of the pressure-sensitive adhesive layer formed at the fabric transport member or the water resistance is improved, and the adhesion in a wide temperature range tends to be further maintained.

The content of the pH adjuster is preferably 0.05% by mass to 1.50% by mass, 0.10% by mass to 1.00% by mass, 0.15% by mass to 0.50% by mass, or 0.20% by mass to 0.30% by mass with respect to the total amount of the aqueous pressure-sensitive adhesive composition. The pH adjuster may be included such that the pH of the aqueous pressure-sensitive adhesive composition is 7.7 to 9.0 or 8.0 to 8.7. By adjusting the content of the pH adjuster to be in the above-described range, the peelability, adhesion, and cleaning resistance of the obtained pressure-sensitive adhesive layer are further improved, and the dispersion stability tends to be further improved.

### 1.3. Water

The content of the water is preferably 30% by mass to 80% by mass, 35% by mass to 70% by mass, or 40% by mass to 60% by mass with respect to the total amount of the aqueous pressure-sensitive adhesive composition.

### 1.4. Surfactant

The aqueous pressure-sensitive adhesive composition may include a surfactant. The surfactant is not particularly limited, and examples thereof include an anionic surfactant, a nonionic surfactant, and a cationic surfactant.

Examples of the anionic surfactant include an alkyl sulfate such as alkyl sulfocarboxylate, alkyl diphenyl ether disulfonate, α-olefin sulfonate, polyoxyethylene alkyl ether acetate, N-acylamino acid and a salt thereof, an N-acylmethyl taurine salt, ammonium lauryl sulfate, or sodium lauryl sulfate, alkyl sulfate polyoxyalkyl ether sulfate, alkyl sulfate polyoxyethylene alkyl ether phosphate, rosin acid soap, castor oil sulfate ester, lauryl alcohol sulfate ester, alkylphenol type phosphate ester, alkyl type phosphate ester, alkylaryl sulfonate, diethyl sulfosuccinate, diethyl hexyl sulfosuccinate, and dioctyl sulfosuccinate.

Examples of the nonionic surfactant include an acetylene glycol-based surfactant, a silicone-based surfactant, polyoxyethylene alkyl ether, polyoxyethylene alkyl phenyl ether, polyoxyethylene fatty acid ester, polyoxyethylene hardened castor oil, propylene glycol fatty acid ester, glycerin fatty acid ester, polyglycerin fatty acid ester, sorbitan fatty acid ester, sucrose fatty acid ester, alkyl polyglycoside, alkyl diethanolamide, and alkyl amine oxide.

Examples of the cationic surfactant include alkylamine salts, fatty acid amidoamine salts, monoalkyl quaternary ammonium salts, dialkyl quaternary ammonium salts, trialkyl quaternary ammonium salts, benzalkonium quaternary ammonium salts, benzethonium chloride, and alkylpyridinium salts.

In the present embodiment, the nonionic surfactant is preferable among these. More specifically, an alkyl ether-based nonionic surfactant is preferable. By using the surfactant, the durability or the water resistance tends to be maintained.

The content of the surfactant is preferably 0.1% by mass to 5% by mass, 0.2% by mass to 4% by mass, or 0.3% by mass to 3% by mass with respect to the total amount of the aqueous pressure-sensitive adhesive composition.

### 1.5. Adhesion Imparting Agent

It is preferable that the aqueous pressure-sensitive adhesive composition does not include an adhesion imparting agent or includes a small amount of an adhesion imparting agent. When the aqueous pressure-sensitive adhesive composition does not include an adhesion imparting agent or includes a small amount of an adhesion imparting agent, the adhesive force of the pressure-sensitive adhesive layer and the effect of suppressing a decrease in adhesive force during brushing tend to be maintained. Representative examples of the adhesion imparting agent include a rosin-based compound, a terpene-based compound, and a hydrocarbon resin. More specific examples of the adhesion imparting agent include: a rosin-based compound such as natural rosin, a modified rosin, a glycerol ester of natural rosin, a glycerol ester of modified rosin, a pentaerythritol ester of natural rosin, or a pentaerythritol ester of modified rosin; a terpene-based compound such as a copolymer of natural terpene, a three-dimensional polymer of natural terpene, an aromatic modified terpene resin, a hydrogenated derivative of an aromatic modified terpene resin, a terpene phenol resin, or a terpene resin (monoterpene, diterpene, triterpene, polypentene, and the like); and a hydrocarbon resin such as an aliphatic petroleum hydrocarbon resin (C5 resin), a hydrogenated derivative of the aliphatic petroleum hydrocarbon resin, an aromatic petroleum hydrocarbon resin (C9 resin) such as a styrene oligomer, or a hydrogenated derivative of the aromatic petroleum hydrocarbon resin.

It is preferable that the aqueous pressure-sensitive adhesive composition does not include the adhesion imparting agent. However, when the aqueous pressure-sensitive adhesive composition includes the adhesion imparting agent, the content of the adhesion imparting agent is preferably 5% by mass or less, 4% by mass or less, 3% by mass or less, 2% by mass or less, or 1% by mass or less with respect to the total amount of the aqueous pressure-sensitive adhesive composition. By adjusting the content of the adhesion imparting agent to be in the above-described range, the adhesive force of the obtained pressure-sensitive adhesive layer and the effect of suppressing a decrease in adhesive force during brushing tend to be maintained. From the same viewpoint, the total content of compounds selected from the group consisting of the rosin-based compound, the terpene-based compound, and the hydrocarbon resin is preferably in the same range as described above.

### 1.6. Organic Solvent

From the viewpoint of reducing the environmental burden or the effect on a human body, it is preferable that the aqueous pressure-sensitive adhesive composition according to the present embodiment does not include an organic solvent. In addition, when the aqueous pressure-sensitive adhesive composition includes the organic solvent, the content of the organic solvent is preferably 5.0% by mass or less, 2.5% by mass or less, or 1.0% by mass or less with respect to the total amount of the aqueous pressure-sensitive adhesive composition. As a result, the environmental burden can be reduced, the amount of VOC (volatile organic compounds) during the use of the aqueous pressure-sensitive adhesive composition can be reduced, and thus the work environment tends to be further improved.

### 1.7. Color Material

It is preferable that the aqueous pressure-sensitive adhesive composition according to the present embodiment does not include a color material. In addition, when the aqueous pressure-sensitive adhesive composition includes the color material, the content of the color material is preferably 1.0% by mass or less, 0.5% by mass or less, or 0.3% by mass or less with respect to the total amount of the aqueous pressure-sensitive adhesive composition. As a result, the aqueous pressure-sensitive adhesive composition according to the present embodiment is clearly distinguished from a coloring composition such as an ink composition, a printing paste, or a coating material.

### 2. Adhesion Imparting Method

An adhesion imparting method according to the present embodiment includes attaching the above-described aqueous pressure-sensitive adhesive composition to a surface of a fabric transport member of an ink jet textile printing apparatus to form a pressure-sensitive adhesive layer.

The step of forming the pressure-sensitive adhesive layer is a step of attaching the above-described aqueous pressure-sensitive adhesive composition to a surface of a fabric transport member to form a pressure-sensitive adhesive layer. A method of attaching the aqueous pressure-sensitive adhesive composition to the fabric transport member is not particularly limited. The aqueous pressure-sensitive adhesive composition may be uniformly applied to the entire surface of the fabric transport member using a blade or the like, or may be applied to a part of the surface of the fabric transport member in a predetermined pattern.

In addition, in the pressure-sensitive adhesive layer forming step, the aqueous pressure-sensitive adhesive composition may be dried to form a pressure-sensitive adhesive layer. The drying temperature is preferably 10° C. to 60° C. or 20° C. to 40° C. In addition, the drying time is preferably 1 to 24 hours or 2 to 8 hours. As a result, the water resistance and the mechanical strength of the obtained pressure-sensitive adhesive layer tend to be further improved.

### 3. Ink Jet Textile Printing Apparatus

An ink jet textile printing apparatus according to the present embodiment includes: a transport mechanism that bonds a fabric to a pressure-sensitive adhesive layer of the aqueous pressure-sensitive adhesive composition formed at a surface of a fabric transport member to transport the fabric; a recording portion that performs textile printing recording on the fabric bonded to the pressure-sensitive adhesive layer using an ink jet head; and a cleaning portion that cleans the pressure-sensitive adhesive layer from which the fabric is peeled off after the textile printing recording.

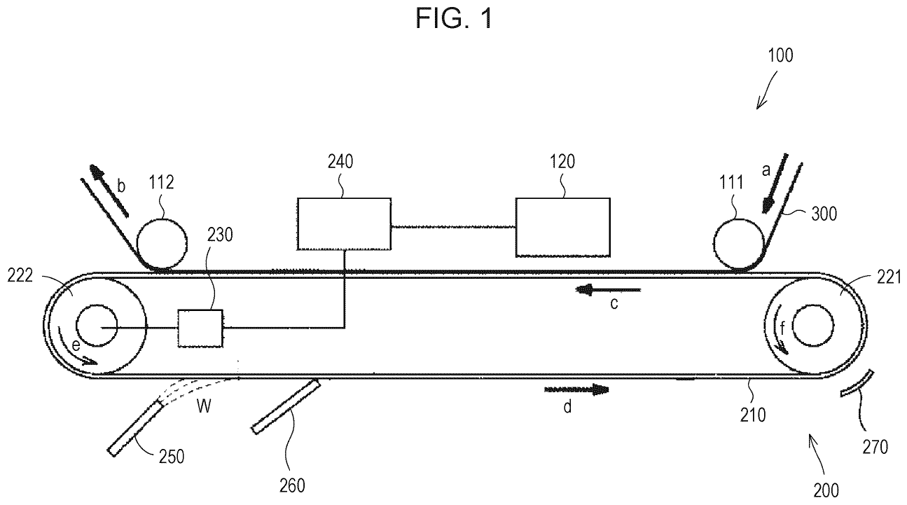

An ink jet textile printing apparatus 100 according to the present embodiment will be described with reference to FIG. 1. FIG. 1 is an overall configuration diagram illustrating the ink jet textile printing apparatus 100 including a transport device 200 according to the present embodiment. In FIG. 1, arrows a and b indicate a transport direction of a recording medium 300. Arrows c and d indicate a rotation direction of a fabric transport member 210. Arrows e and f indicate a rotation direction of transport rollers 221 and 222.

The ink jet textile printing apparatus 100 may include the transport device 200 for bonding the recording medium to the surface to transport the recording medium, recording medium transport rollers 111 and 112, and a recording portion 120. The recording medium 300 transported from the direction a is pressed against the fabric transport member 210 by the recording medium transport roller 111 to bond the recording medium 300 to the surface of the fabric transport member 210.

In a state where the recording medium 300 is bonded to the surface of the fabric transport member 210, the recording medium 300 is transported to a region immediately below the recording portion 120 by the transport device 200 such that the recording medium 300 is recorded by the recording portion 120. Next, in the recording medium transport roller 112, the fabric transport member 210 and the recording medium 300 are peeled off from each other.

The recording portion 120 may discharge the ink composition or the like using an ink jet method. In the present embodiment, it is assumed that the recording portion 120 performs printing on textile fabric as the recording medium 300 using an ink jet head, but the present disclosure is not limited thereto.

The transport device 200 may include a pair of transport rollers 221 and 222, the fabric transport member 210, a drive motor 230, a control device 240, a cleaning portion 250, a removal member 260, and a heater 270.

The transport rollers 221 and 222 are rollers for transporting the fabric transport member 210 in a given direction. In addition, the fabric transport member 210 may be a belt member including the pressure-sensitive adhesive layer on the surface, or is provided around the transport rollers 221 and 222. The fabric transport member 210 transports the recording medium in the arrow c direction when the drive motor 230 rotates the transport rollers 221 and 222. The control device 240 may control either or both of the transport device 200 and the ink jet textile printing apparatus 100.

The cleaning portion 250 cleans the surface of the fabric transport member 210 from which the recording medium 300 is peeled off. The cleaning portion 250 cleans the component of the recording medium 300 and a colorant for printing attached to the fabric transport member 210 during printing. The cleaning portion 250 may include a pump (not illustrated), a water spray port, and a water spray pipe.

The removal member 260 removes water attached to the fabric transport member 210 by the cleaning portion 250. The removal member 260 is not particularly limited, and examples thereof include a blade. As a material of the blade, an elastic material is preferable. Further, from the viewpoint of wear resistance, polyurethane is preferable. A contact portion with the fabric transport member 210 may have a rectangular shape in cross section or may have a shape where a tip is obliquely cut.

The heater 270 may be provided downstream of the cleaning portion 250 and upstream of the recording medium transport roller 111 where the bonding step is performed. By heating the pressure-sensitive adhesive layer with the heater 270, the (meth)acrylic resin forming the pressure-sensitive adhesive layer is softened, and the adhesive force tends to be further improved.

As the fabric transport member 210, an elastic material is preferable. A heater (not illustrated) for heating the fabric transport member 210 may be provided. In the step of cleaning the fabric transport member 210, a bucket portion (not illustrated) for receiving cleaning water, a brush (not illustrated) for cleaning the fabric transport member 210, a sponge (not illustrated), or the like may be used.

Examples of the recording medium 300 include a fabric formed of a natural fiber or a synthetic fiber, for example, silk, cotton, wool, nylon, polyester, or rayon. In addition, the fabric may be woven fabric, knitted fabric, non-woven fabric, or the like.

### 4. Fabric Transport Member of Ink Jet Textile Printing Apparatus

The fabric transport member of the ink jet textile printing apparatus according to the present embodiment includes a pressure-sensitive adhesive layer derived from the above-described aqueous pressure-sensitive adhesive composition on the surface. The fabric transport member is not particularly limited. For example, an elastic material is preferable, and a material including a urethane resin is more preferable. By using the above-described aqueous pressure-sensitive adhesive composition in the fabric transport member, the adhesion between the pressure-sensitive adhesive layer and the fabric transport member is further improved, and the water resistance is improved.

### 5. Ink Jet Textile Printing Method

An ink jet textile printing method includes: bonding a fabric to a pressure-sensitive adhesive layer of the above-described aqueous pressure-sensitive adhesive composition formed at a surface of a fabric transport member of an ink jet textile printing apparatus to transport the fabric; performing textile printing recording on the fabric bonded to the pressure-sensitive adhesive layer using an ink jet head; and cleaning the pressure-sensitive adhesive layer from which the fabric is peeled off after the textile printing recording.

### 5.1. Transport Step

The transport step is a step of bonding the fabric to a pressure-sensitive adhesive layer of the above-described aqueous pressure-sensitive adhesive composition formed at a surface of a fabric transport member of an ink jet textile printing apparatus. The bonding method is not particularly limited, and examples thereof include a bonding method of pressing both of the fabric and the pressure-sensitive adhesive layer using a transport roll as illustrated in FIG. 1.

### 5.2. Recording Step

The recording step is a step of performing textile printing recording on the fabric bonded to the pressure-sensitive adhesive layer using an ink jet head. In the recording step, in a state where the fabric transport member and the fabric adhere to each other through the pressure-sensitive adhesive layer of the surface of the fabric transport member, the fabric is transported, and ink is discharged from the recording portion 120 and is attached to the fabric in the process of the transport. Next, the fabric to which the ink is attached may be peeled off and recovered from the pressure-sensitive adhesive layer.

### 5.3. Cleaning Step

The cleaning step is a step of cleaning the pressure-sensitive adhesive layer from which the fabric is peeled off after the textile printing recording. In the cleaning step, dust such as waste thread derived from the attached fabric in the recording can be removed from the pressure-sensitive adhesive layer surface.

### EXAMPLES

Hereinafter, the present disclosure will be described in more detail with reference to Examples and Comparative Examples. The present disclosure is not limited by the following Examples.

### 1. Manufacturing of Aqueous Pressure-Sensitive Adhesive Composition

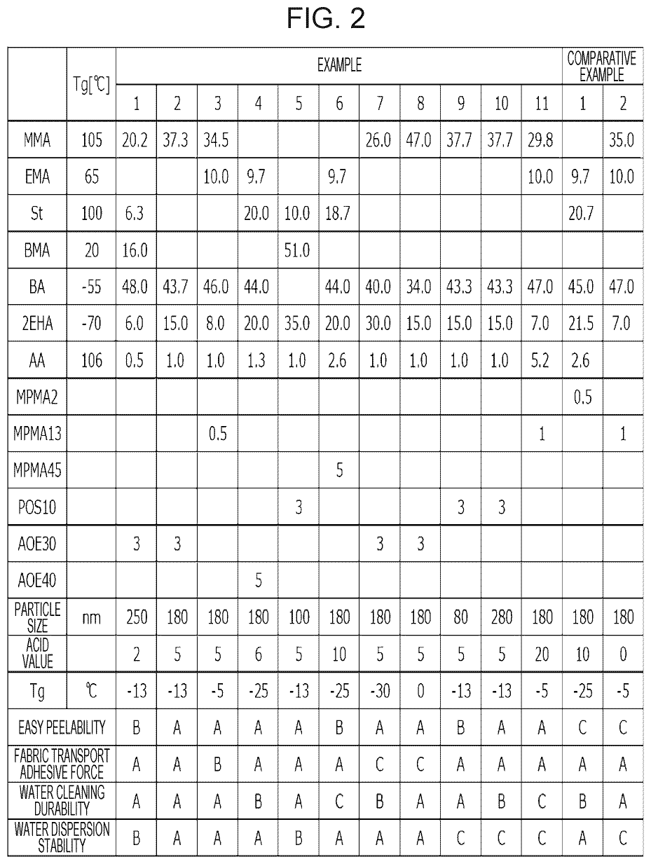

114 g of ion exchange water was added to a reactor including a stirrer, a reflux cooling tube, a thermometer, a nitrogen introduction tube, and a dropping funnel, and was heated to 82° C. Next, 497 g in total of a monomer, 118 g of ion exchange water, and 13 g of HITENOL NF-08 (polyoxyethylene styrenated phenyl ether sulfuric ammonium salt, a nonionic surfactant, manufactured by DKS Co. Ltd.) weighed to have a composition ratio shown in FIG. 2 were added, mixed, and stirred. 248 g of a 2% by mass aqueous solution of ammonium persulfate as a polymerization initiator was charged into the uniform solution at 82° C. for 1.5 hours.

All kinds of the components described above were charged, the solution was cooled after keeping the temperature for 1 hour, ion exchange water was added, and ammonia water as a pH adjuster was charged. Next, by removing coarse particles filtered through a 150 mesh nylon filter, an aqueous pressure-sensitive adhesive composition (solid content: 50.5% by mass) including a (meth)acrylic resin having a composition illustrated in FIG. 2 was obtained. The amount of each of the monomers used in FIG. 2 is represented by % by mass.

### 1.1. Monomer

Each of the monomers regarding the constituent units of the (meth)acrylic resins illustrated in FIG. 2 is as follows.
MMA: methyl methacrylate
EMA: ethyl methacrylate
St: styrene
BMA: butyl methacrylate
BA: butyl acrylate
2EHA: 2-ethylhexyl acrylate
AA: acrylic acid
MPMA2: methoxy polyalkylene glycol methacrylate n=2
MPMA13: methoxy polyalkylene glycol methacrylate n=13
MPMA45: methoxy polyalkylene glycol methacrylate n=45
POS10: polyoxyethylene alkyl ether sulfuric ester ammonium salt n=10, X=SO₃NH₄
AOE30: allyloxymethyl alkoxyethyl hydroxypolyoxyethylene n=30, X=H
AOE40: allyloxymethyl alkoxyethyl hydroxypolyoxyethylene n=40, X=H

The number n in MPMA2, MPMA13, and MPMA45 represents the number n of repetitions in the following chemical formula.

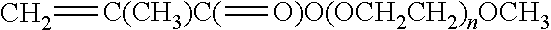

In addition, the number n in POS10, AOE30, and AOE40 represents the number n of repetitions in the following chemical formula, and a functional group X represents X in the following chemical formula.

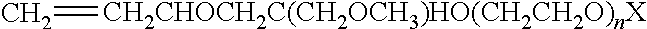

### 1.2. Measurement Method

The average particle size refers to a value of D50 obtained by measurement using a zeta potential and particle size measuring system “ELSZ-1000ZS” (manufactured by Otsuka Electronics Co., Ltd.).

The acid value refers to a value obtained by acid value measurement according to JIS K2501.

The Glass transition temperature Tg was measured according to JIS K 7121, and a value obtained by the measurement using a differential scanning calorimeter “DSC8000” (manufactured by Perkin Elmer Inc.) was shown.

### 2. Evaluation Method

### 2.1. Easy Peelability

The aqueous pressure-sensitive adhesive composition obtained as described above was applied with a thickness of 0.2 mm to a urethane belt, and was dried under conditions of a humidity of 25%, 50° C., and 30 minutes to form a pressure-sensitive adhesive layer. Next, the pressure-sensitive adhesive layer was dipped in water, and the peel-off state from the belt was verified after 1 hour. Depending on the peel-off state, the easy peelability was evaluated based on the following evaluation standards.

### Evaluation Standards

A: the pressure-sensitive adhesive layer was clearly peeled off
B: the pressure-sensitive adhesive layer was peeled off although a period of time was required
C: the pressure-sensitive adhesive layer was not clearly peeled off

### 2.2. Fabric Transport Adhesive Force

The aqueous pressure-sensitive adhesive composition obtained as described above was applied with a thickness of 0.2 mm to a glass slide having a width of 25 mm, and was dried under conditions of a humidity of 258, 50° C., and 30 minutes to form a pressure-sensitive adhesive layer. Next, cotton having a width of 50 mm and the pressure-sensitive adhesive layer were pressed with rollers at a pressure of 1 kgf/50 mm, and a 180° peel force was measured. Depending on the 180° peel force, the fabric transport adhesive force was evaluated based on the following evaluation standards. The measurement was performed at 23° C.

### Evaluation Standards

A: 1.0 N/50 mm or more
B: 0.2 N/50 mm or more and less than 1.0 N/50 mm
C: less than 0.2 N/50 mm

### 2.3 Water Cleaning Durability

A nylon brush wetted with water was rotated at 200 rpm and was pressed against the pressure-sensitive adhesive layer formed in the evaluation of the fabric transport adhesive force at a pressure of 1.0 N/cm, and the pressure-sensitive adhesive layer surface after 200 hours was visually inspected. Depending on the visual inspection result, the water cleaning durability was evaluated based on the following evaluation standards. As the nylon brush, a brush formed of 6.10 nylon having a bristle diameter of 0.3 mm, a bristle length of 30 mm, and a brush diameter of 16 mm was used.

### Evaluation Standards

A: no scratches
B: slightly scratched
C: unevenness was observed

### 2.4. Water Dispersion Stability

100 g of the aqueous pressure-sensitive adhesive composition was charged into a 200 mL glass bottle and was left to stand at 60° C. for 2 weeks. Next, the state of the aqueous pressure-sensitive adhesive composition in the glass bottle was visually inspected. Depending on the visual inspection result, the water dispersion stability was evaluated based on the following evaluation standards.

### Evaluation Standards

A: no thickening and aggregation
C: thickening and aggregation occurred

### 3. Evaluation Result

FIG. 2 illustrates the composition and the evaluation results of the aqueous pressure-sensitive adhesive composition used in each of the examples. It can be seen from FIG. 2 that, since the aqueous pressure-sensitive adhesive composition for forming a pressure-sensitive adhesive layer on the surface of the fabric transport member of the ink jet textile printing apparatus includes the predetermined (meth)acrylic resin, the peelability of the pressure-sensitive adhesive layer formed at the fabric transport member is excellent, and the cleaning resistance, adhesive force, and dispersion stability are further improved.

What is claimed is:

1. An aqueous pressure-sensitive adhesive composition for forming a pressure-sensitive adhesive layer at a surface of a fabric transport member of an ink jet textile printing apparatus, the aqueous pressure-sensitive adhesive composition comprising:
a (meth)acrylic resin; and
water, wherein
the (meth)acrylic resin includes a constituent unit having an alkylene oxide chain of which the number of repetitions is 10 or more at a side chain, and
an acid value of the (meth)acrylic resin is more than 0 mgKOH/g.

2. The aqueous pressure-sensitive adhesive composition according to claim 1, wherein
a glass transition temperature of the (meth)acrylic resin is −25° C. to −5° C.

3. The aqueous pressure-sensitive adhesive composition according to claim 1, wherein
the acid value of the (meth)acrylic resin is 2.0 mgKOH/g to 10 mgKOH/g.

4. The aqueous pressure-sensitive adhesive composition according to claim 1, wherein
a content of the constituent unit having the alkylene oxide chain is 0.5% by mass to 5.0% by mass with respect to all of constituent units of the (meth)acrylic resin.

5. The aqueous pressure-sensitive adhesive composition according to claim 1, wherein
an average particle size of the (meth)acrylic resin is 100 nm to 250 nm.

6. An adhesion imparting method comprising:
attaching the aqueous pressure-sensitive adhesive composition according to claim 1 to a surface of a fabric transport member of an ink jet textile printing apparatus to form a pressure-sensitive adhesive layer.

7. An ink jet textile printing apparatus comprising:
a transport mechanism that transports a fabric, the fabric being bonded to a pressure-sensitive adhesive layer of the aqueous pressure-sensitive adhesive composition according to claim 1 formed at a surface of a fabric transport member;
a recording portion that performs textile printing recording on the fabric bonded to the pressure-sensitive adhesive layer using an ink jet head; and
a cleaning portion that cleans the pressure-sensitive adhesive layer from which the fabric is peeled off after the textile printing recording.

8. A fabric transport member of an ink jet textile printing apparatus, the fabric transport member comprising:
a pressure-sensitive adhesive layer derived from the aqueous pressure-sensitive adhesive composition according to claim 1 on a surface.

9. An ink jet textile printing method comprising:
transporting a fabric, the fabric being bonded to a pressure-sensitive adhesive layer of the aqueous pressure-sensitive adhesive composition according to claim 1 formed at a surface of a fabric transport member of an ink jet textile printing apparatus;
performing textile printing recording on the fabric bonded to the pressure-sensitive adhesive layer using an ink jet head; and
cleaning the pressure-sensitive adhesive layer from which the fabric is peeled off after the textile printing recording.
